(19) United States
(12) Patent Application Publication
(10) Pub. No.: US 2025/0064066 A1
(43) Pub. Date: Feb. 27, 2025

(54) DEVICE FOR CUTTING AND HOLDING A DONUT

(71) Applicant: Anthony Dowdy, West Palm Beach, FL (US)

(72) Inventor: Anthony Dowdy, West Palm Beach, FL (US)

(21) Appl. No.: 18/810,001

(22) Filed: Aug. 20, 2024

Related U.S. Application Data
(60) Provisional application No. 63/578,189, filed on Aug. 23, 2023.

(51) Int. Cl. A21C 15/04; B26B 13/08; B26B 13/20

(52) U.S. Cl. CPC A21C 15/04; B26B 13/08; B26B 13/20

(57) ABSTRACT

Devices for use with food, preferably donuts, are provided. The devices are designed to allow a user to cut a donut, to hold a donut or portions thereof, to be used to serve a donut or portions thereof, or combinations thereof. In one embodiment, the donut cutter may comprise a first scissors member and a second scissors member. The first scissors member and the second scissors member are operatively connected via a pivot member to allow the donut cutter to move between various orientations. In another embodiment, the donut cutter may comprise a first arm and second arm. The first arm and the second arm are linked tougher via a wall or segment at the first end.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 63/578,189, entitled, “DEVICE FOR CUTTING AND HOLDING A DONUT”, filed on Aug. 23, 2023. The contents of the above referenced application are incorporated herein by reference in their entirety.

### FIELD OF THE INVENTION

The invention relates to devices for use in the food industry; to devices for cutting and serving food; and more particularly, to devices for cutting, holding, and serving donuts.

### BACKGROUND OF THE INVENTION

Donuts, or fried cakes of sweetened dough, usually in the shape of a circle, are well known and enjoyed by many all over the world. While very enjoyable, it is often unhealthy to eat an entire donut in one sitting. In addition, donuts often are served in a variety pack of twelve or more, with several different flavors or types. In this case, a person may want to try various kinds of the donuts, often times eating just a smaller portion of each flavor. Typically, a person may use a knife to cut the donut into smaller portions. This often results in a non-hygienic interaction, as the user typically holds the donut with their hands/fingers in order to cut a larger donut into a smaller portion. When the user retrieves the cut portion, they often touch the non-cut portion as well. In addition, utensils can be clumsy and not very intuitive when used to cut donuts. What is needed, therefore, is a device that can be used to hygienically obtain smaller portions of a donut. A device which can be easily used and is more intuitive cutting, holding, and be used in serving a donut would be useful.

### SUMMARY OF THE INVENTION

Embodiments of a device for use with food are provided. The device, referred to generally as a donut cutter, is designed to allow a user to cut a donut, to hold a donut or portions thereof, to be used to serve a donut or portions thereof, or combinations thereof. In one embodiment, the donut cutter may comprise a first scissors member and a second scissors member. The first scissors member and the second scissors member are operatively connected via a pivot member to allow the donut cutter to move between various orientations. In another embodiment, the donut cutter may comprise a first arm and a second arm. The first arm and the second arm are linked together via a wall or segment at the first end, and are moveable between two orientations or positions.

Accordingly, it is an objective of the invention to provide a device for use with food or bakery products.

It is a further objective of the invention to provide a device for use with donuts.

It is yet another objective of the invention to provide a device designed to cut a donut.

It is yet another objective of the invention to provide a device designed to hold a donut or portions thereof.

It is yet another objective of the invention to provide a device designed to allow a user to serve a donut or portions thereof.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a top view of an illustrative embodiment of a donut cutter, showing a first side and in a first, closed position;

FIG. 2 is an alternative view of the donut cutter illustrated in FIG. 1, showing a second side;

FIG. 3 is a top perspective view of the donut cutter, showing the first side and in a second, open position;

FIG. 4 is a right view of the donut cutter, showing the first side and in the second, open position;

FIG. 5 a left view of the donut cutter, showing the first side and in the second, open position;

FIG. 6 is a top view of the donut cutter, showing the second side and in the second, open position;

FIG. 7 is a right view of the donut cutter, showing the second side and in the second, open position;

FIG. 8 is a left view of the donut cutter, showing the second side and in a second, open position;

FIG. 9 illustrates the engagement of the donut cutter with a donut;

FIG. 10 illustrates the donut cutter with a donut engagement member extending away from the second scissors member;

FIG. 11 is a top view of an illustrative embodiment of a donut cutter, showing a first side and in a first position;

FIG. 12 is an alternate view of the donut cutter illustrated in FIG. 11, showing a first side and in a first position;

FIG. 13 is an alternate view of the donut cutter illustrated in FIG. 11, showing a second side and in a first position;

FIG. 14 illustrates the donut cutter illustrated in FIG. 11 in which the first arm and the second arm are in a second position;

FIG. 15 illustrates a side view (first side) of the donut cutter illustrated in FIG. 11;

FIG. 16 illustrates a side view (second side) of the donut cutter illustrated in FIG. 11; and

FIG. 17 illustrates the donut cutter illustrated in FIG. 11 with a donut engagement member extending away from the first arm.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

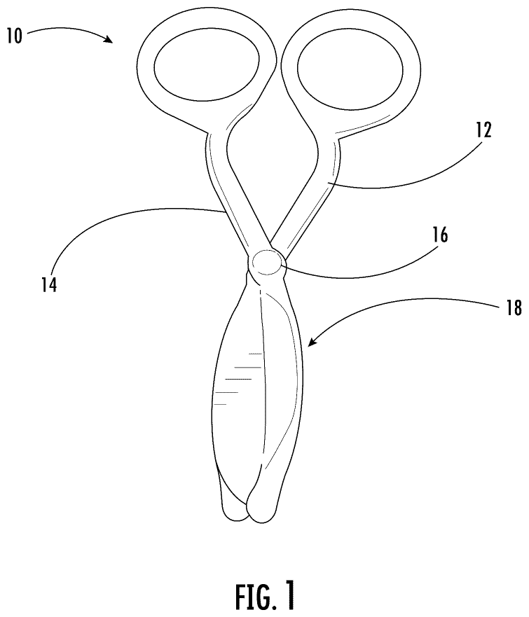

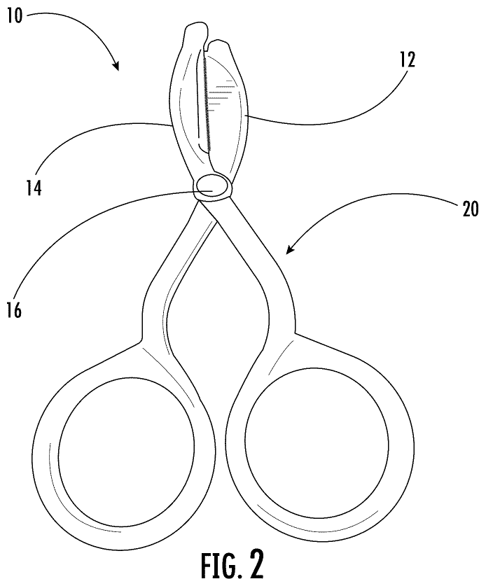

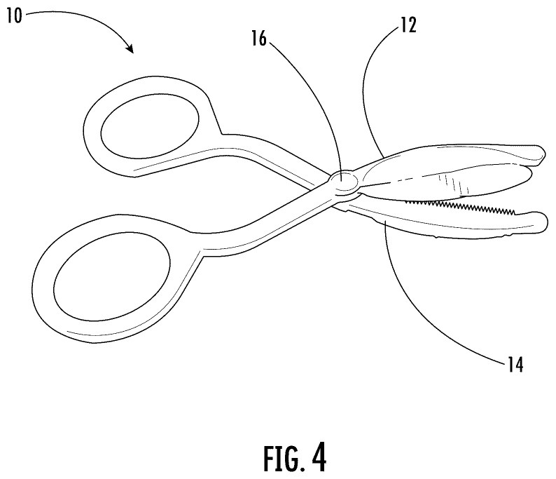

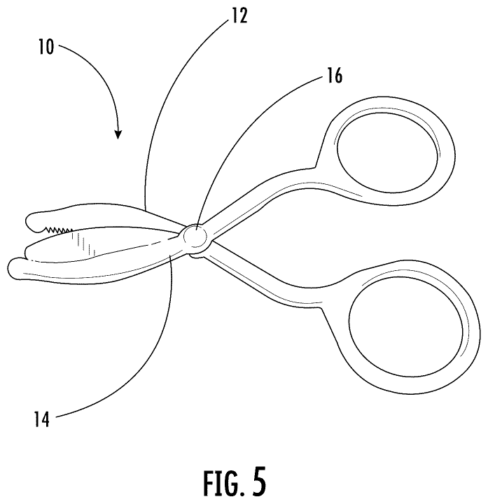

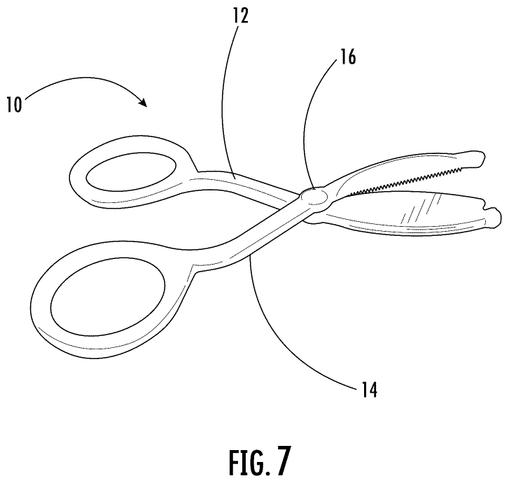

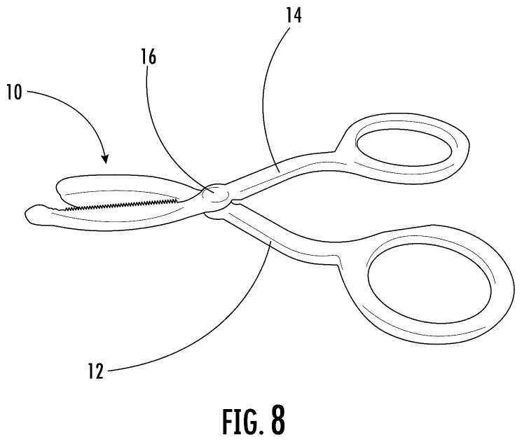

Referring generally to FIGS. 1-10, and specifically to FIGS. 1-2, an illustrative embodiment of a device for use with food or bakery products, referred to generally as a donut cutter 10, is shown. While the donut cutter 10 is illustrated for use with donuts, the donut cutter 10 may find use with other pastries, cakes, or food or bakery products. The donut cutter 10 is designed to allow a user to cut a donut, to hold a donut or portions thereof, to aid a user to serve a donut or portions thereof, or combinations thereof. The donut cutter 10 may be made of any material, preferably food safe material, such as plastic, metal, wood, rubber, or mixed materials, such as plastic and rubber.

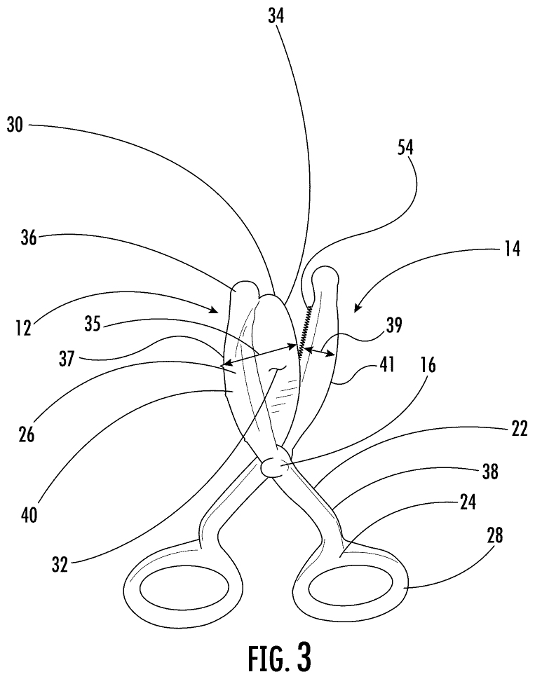

The donut cutter 10 may comprise a first scissors member 12 and a second scissors member 14. The first scissors member 12 and the second scissors member 14 are operatively connected via a pivot member 16, illustrated herein as a pivot pin. Alternatively, the first scissors member 12 and the second scissors member may be pivotally connected via a rivet, a screw, a stud, or the like. As such, the first scissors member 12 and the second scissors member 14 may be manipulated to place the donut cutter 10 in a first, closed position, see FIGS. 1-2, and to a second open position, see FIGS. 3-8. As illustrated in FIGS. 1-2, the closed position includes the first scissors member 12 and the second scissors member 14 aligned together, with no space or gaps between the two. The open position includes the first scissors member 12 and the second scissors member 14 positioned to have a space or a gap between the two. The size or length of the space or gap of separation can be variable depending on the size of the donut being cut, held, or served. The donut cutter 10 may further be defined by a first side 18 in which the first scissors member 12 is aligned or rests on top of the second scissors member 14 when in the closed position, see FIG. 1. The donut cutter 10 may include a second side 20 in which the second scissors member 14 is aligned, or rests on top of the first scissors member 12 when in the closed positon (when second side is facing the viewer, see FIG. 2; the second scissors member 14 is aligned, or rests below the first scissors member 12 when in the closed positon and the first side is facing the viewer).

The first scissors member 12 is defined by an elongated body 22 having a first end defined by a first handle member 24 and a second end defined by a first blade member 26, see FIGS. 3-5. The first handle member 24 is illustrated as a ring or circular body 28. The ring or circular body 28 is sized and shaped to receive and hold therein a member of a user's hand, such as a finger or thumb. Although the first handle member 24 is describe as having a ring or circular body 28, the body 28 may be any shape that allows receives and holds a user's finger or thumb. The first blade member 26 includes an elongated, flat body 30 having a surface 32. The elongated, flat body 30 extends outwardly, towards the second scissors member 14, terminating in a curved edge 34. The elongated, flat body 30 is designed to act as a holding/securing surface and a cutting surface. The tip 36 of the first scissors member 12 is shown having a rounded or curved shape. Alternatively, a pointed tip may be used. The first scissors member 12 may include a first curved section 38, located on one side relative to the pivot pin 16 and a second curved section 40 located on the other side relative to the pivot pin 16. The second curved section 40 may be congruent with or the same size or shape as to the curvature associated with a donut to ensure proper fit and/or contact when cutting or holding the donut.

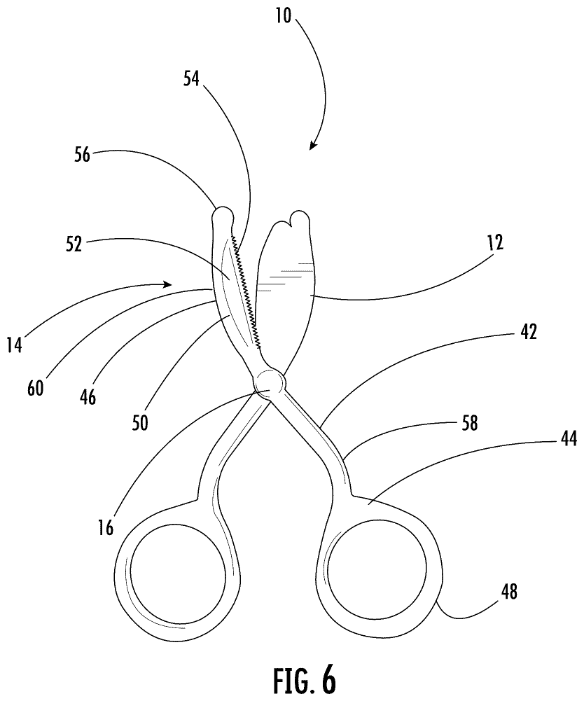

The second scissors member 14 is defined by an elongated body 42 having a first end defined by a second handle member 44 and a second end defined by a second blade member 46, see FIGS. 6-8. The second handle member 44 is illustrated as a ring or circular body 48. The ring or circular body 48 is sized and shaped to receive and hold therein a member of a user's hand, such as a finger or thumb. Although the second handle member 44 is describe as having a ring or circular body 48, the body 48 may be any shape that allows receives and holds a user's finger or thumb. The second blade member 46 includes a body 50 having a surface 52 having a curved serrated edge 54. The body 50 is designed to act as a cutting surface. The tip 56 of the second scissors member 14 is shown having a rounded or curved shape. Alternatively, a pointed tip may be used. The second scissors member 14 may include a first curved section 58 located on one side relative to the pivot pin 16 and a second curved section 60 located on the other side relative to the pivot pin 16. The second curved section 60 may be congruent with or the same size or shape as to the curvature associated with a donut to ensure proper fit and/or contact when cutting or holding the donut.

The first scissors member 12, with the first blade member 26 having the elongated, flat body 30 provides a wider profile than that of the second scissors member 14. The wider profile may be determined by a distance, edge to edge of the first scissors member 12 or second scissors member 14 at least at one section, such as but not limited to within a middle section of the elongated, flat body 30 portion. Accordingly, the width 35, see double arrow of the first scissors member 12 in FIG. 3, defined by a distance or length between the curved surface 34 and an opposing edge surface 37, is greater than a width 39, see double arrow of the second scissors member 14 in FIG. 3, defined by a distance or length between the curved serrated edge 54 and an opposing edge surface 41.

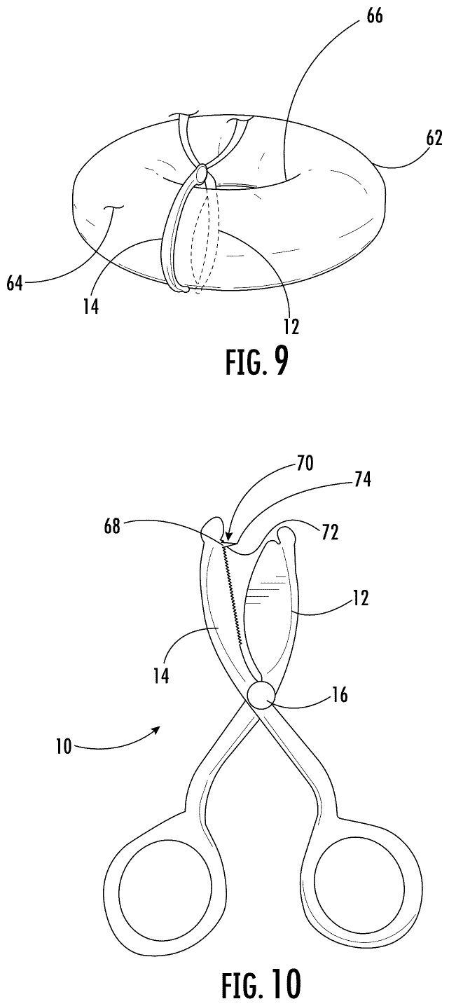

The first blade member second curved section 40 and the second blade member second curved section 60 are of sufficient curvature to ensure proper fit and contact when engaged with and gripping the surfaces of the donut, thereby preventing the donut from slipping out of the grip of the first scissors member 12 and the second scissors member 14. Referring to FIG. 9, a donut 62, having an outer surface 64 and an inner surface 66, is shown. Both the donut outer surface 64 and the donut inner surface 66 have a curvature, as the donut 62 is generally round in shape. The curvature associated with the outer surface 64 and the inner surface 66 for which the first blade member second curved section 40 and the second blade member second curved section 60 may be designed to be the same or similar to engage without having the donut 62 slip or move. As shown in FIG. 9, the donut cutter 10 is engaged with the donut 62. In this orientation, the first blade member second curvature 40 engages with the curvature of the outer surface 64, and the second blade member second curvature 60 engages with the curvature of the inner surface 66.

To aid in securing the donut 62 to the donut cutter 10, the first scissors member 12 or the second scissors member 14 may include a donut engagement member 68 configured to engage with and secure the donut 62 to the donut cutter 10. Referring to FIG. 10, the donut engagement member 68 is illustrated as a spike 70 having a body 72 extending away from the second scissors member 14. Although shown having one donut engagement member 68, the first scissors member 12 may include two or more engagement members 68. The body 72 is shown having a terminal pointed end 74. While shown attached to or integrally formed from the second scissors member 14, the donut engagement member(s) 68 may be attached to or integrally formed from the first scissors member 12. Alternatively, both the first scissors member 12 and the second scissors member 14 may include the donut engagement member(s) 68.

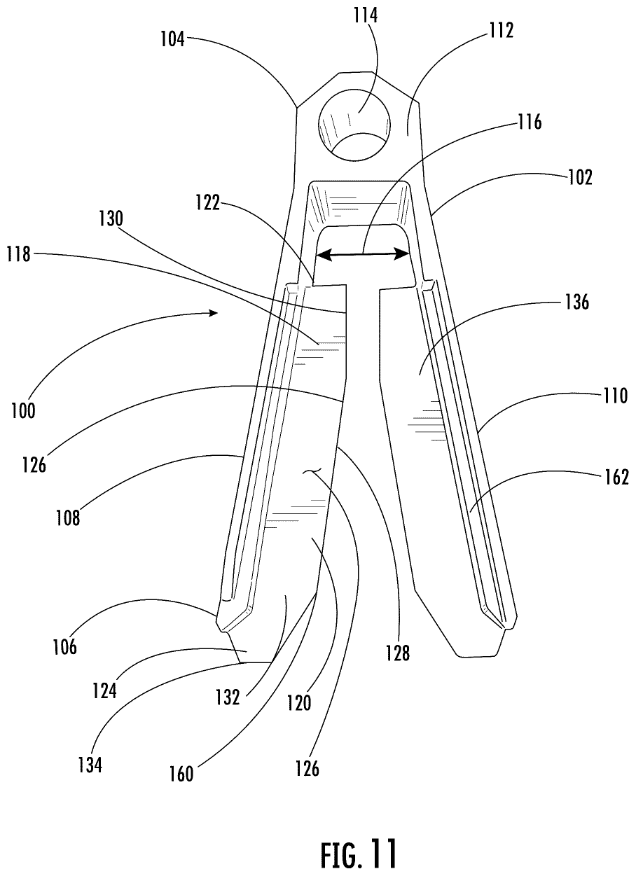

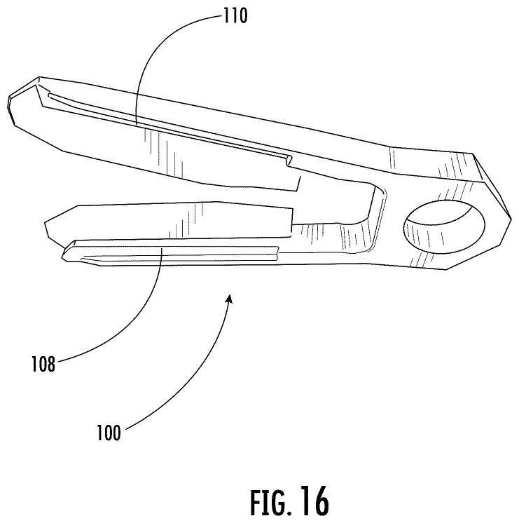

Referring to FIGS. 11-17, a device for use with food or bakery products, referred to generally as a donut cutter 100, is illustrated. While the donut cutter 100 is illustrated for use with donuts, donut cutter 100 may find use with other pastries, cakes, or food or bakery products. Having the same function as the donut cutter 10, the donut cutter 100 is designed to allow a user to cut a donut, to hold a donut or portions thereof, to allow a user to serve a donut or portions thereof, or combinations thereof. The donut cutter 100 may be made of any material, preferably food safe material, such as plastic, metal, wood, rubber, or mixed materials, such as plastic and rubber.

The donut cutter 100 may comprise a main body 102 having a first end 104 and a second, opposing end 106, see FIG. 11. The main body 102 comprises a first arm 108 and a second arm 110. The first arm 108 and the second arm 110 are linked together via a wall or segment 112 at the first end 104, thus forming connecting area. The wall or segment 112 may include an opening 114 sized and shaped to allow an object, such as a hook or pin, to fit within, thus allowing the donut cutter 100 to be secured thereto/thereon. The first arm 108 and the second arm 110 are separated by a space or gap 116; the space or gap 116 forming an interior portion of the donut cutter 100.

The first arm 108 includes a first cutting and holding member 118 used in cutting, holding, and serving portions of a donut, see FIG. 11. The first cutting and holding member 118 comprises a main body 120 having a first end 122 and a second opposing end 124. The first cutting and holding member main body 120 may be defined by a wall or surface 126 extending outwardly and away from the first arm 108 (i.e., towards the direction into the interior region). The outer edge 126 includes a generally linear section 128, a first angled section 130 at the first end 122, and a second angled surface 132 at the second end 124. The first cutting and holding member 118 ends in a flat or non-pointed tip 134. The tip 134 extends out past the donut cutter main body second end 106. Alternatively, tip 134 may be flush with the donut cutter main body second end 106, or extend a distance which is below the donut cutter main body second end 106

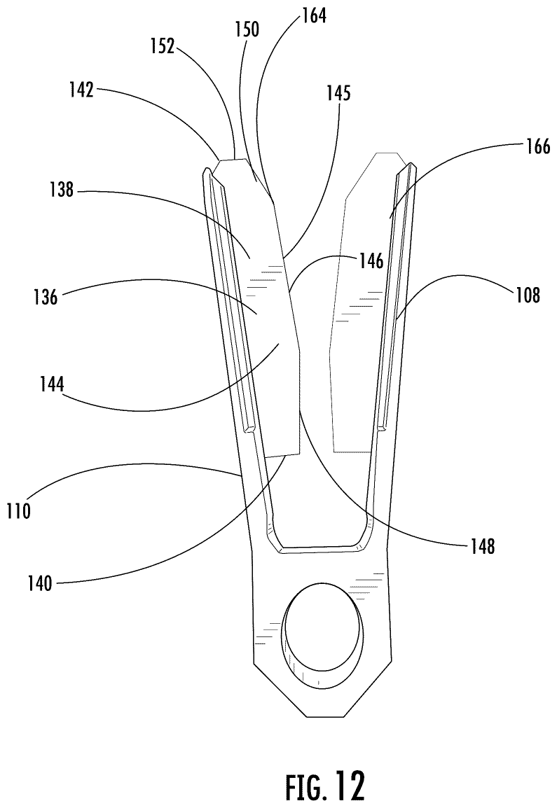

The second arm 110 includes a second cutting and holding member 136 used in cutting, holding, and serving portions of a donut, see FIG. 12. The second cutting and holding member 136 comprises a main body 138 having a first end 140 and a second opposing end 142. The second cutting and holding member main body 138 may be defined by a wall or surface 144 extending outwardly and away from the second arm 110 (i.e., towards the direction into the interior region). An outer edge 145 includes a generally linear section 146, a first angled section 148 at the first end 140 and second angled surface 150 at the second end 142. The second cutting and holding member 136 ends in a flat or non-pointed tip 152. The tip 152 extends out past the donut cutter main body second, opposing end 106. Alternatively, tip 152 may be flush with the donut cutter main body second end 106, or extend to a distance which is below the donut cutter main body second end 106.

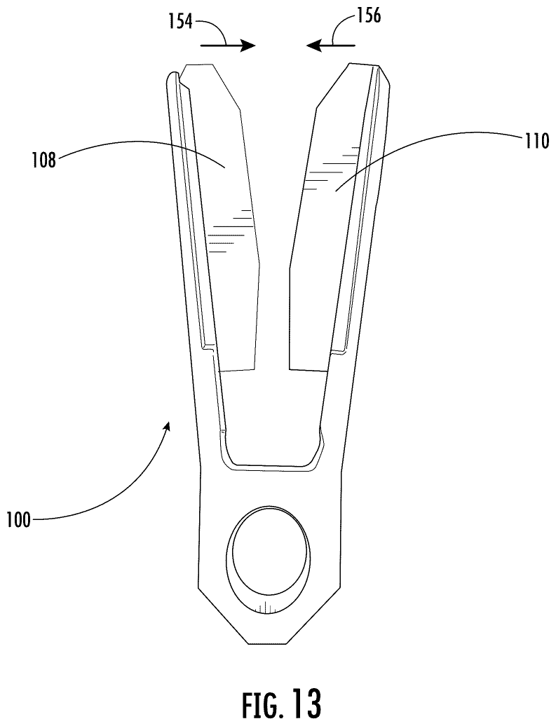

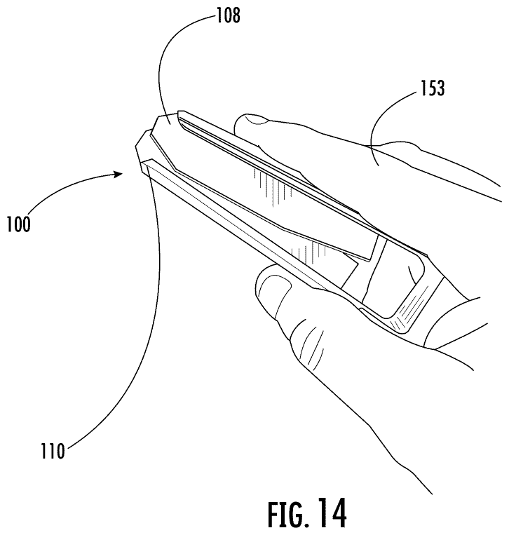

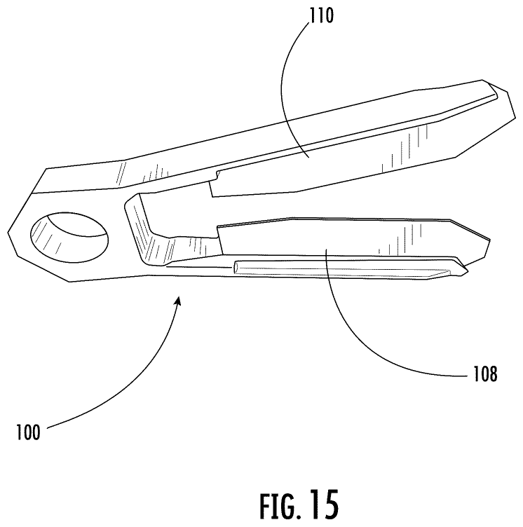

The first arm 108 and the second arm 110 are designed to move when a force is applied, returning to the original positioning when the force is removed. The movements to arms may include movement of the first arm 108, movement of the second arm 110, or movement of both the first arm 108 and the second arm 110. As such, movement of the first arm 108 may be independent of movement of the second arm (and vice versa) or be designed so the first arm 108 and the second arm 110 move at the same time. Referring to FIG. 13 and FIG. 14, as a force (user's fingers 153) is applied, the first arm 108 and the second arm 110 move in a direction towards the inner section, see arrow 154, direction of the first arm 108, and arrow 156, the direction of the second arm 110. When the force is applied, the first cutting and holding member 118 aligns with and rests above (or below, depending on the view) the second cutting and holding member 136 (the first arm 108 and the second arm 110 being arranged in an off-set orientation). When closed, a pointed portion 160 (see FIG. 11) of the first cutting and holding member body 120 rests along a stopping surface 162, illustrated herein as a ridge or ledge in the second arm 110. A pointed portion 164 (see FIG. 12) of the second cutting and holding member body 136 rests along a stopping surface 166, illustrated herein as a ridge or ledge in the first arm 110. Once released, i.e., the force is removed, the first arm 108 and the second arm 110 return to their original positions.

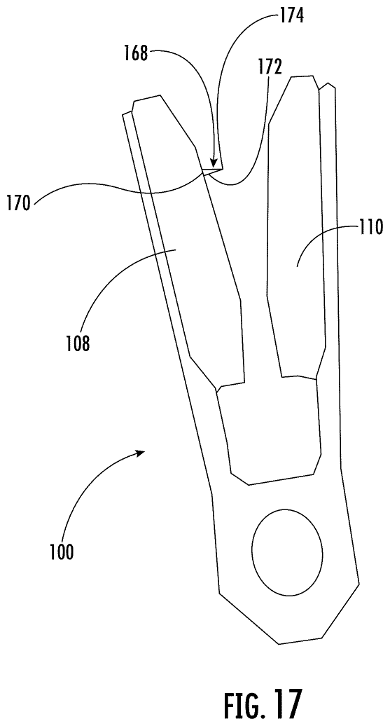

To aid in securing a donut to the donut cutter 100, the first arm 108 or the second arm 110 may include a donut engagement member 168 (similar to donut engagement member 68) configured to engage with and secure a donut to the donut cutter 100. Referring to FIG. 17, the donut engagement member 168 is illustrated as a spike 170 having a body 172 extending away from the first arm 108. Although shown having one donut engagement member 168, the first arm 108 may include two or more engagement members 168. The body 172 is shown having a terminal pointed end 174. While shown attached to or integrally formed from the first arm 108, the donut engagement member(s) 168 may be attached to or integrally formed from the second arm 110. Alternatively, both the first arm 108 and the second arm 110 may include the donut engagement member(s) 168.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for serving or cutting food comprising:
a first member;
a second member; and
a pivot member operatively connecting said first member and said second member; wherein said first member and said second member are movable between a closed position and an open position, wherein said first member or said second member are moveable between an open position and a closed position.

2. The device according to claim 1, wherein when oriented in the closed positon, the first member is aligned or rests on top of the second member or the second member is aligned or rests on top of the first member.

3. The device according to claim 1, wherein said first scissors member has a different profile than that of the of the second scissors member.

4. The device according to claim 1, wherein said first scissors member has a wider profile than that of the second scissors member.

5. The device according to claim 1,
said first member comprises an elongated body having a first end defined by a first handle member and a second end defined by a first blade member; and
said second member comprises an elongated body having a first end defined by a second handle member and a second end defined by a second blade member.

6. The device according to claim 5, wherein
said first handle member comprises a ring or circular body sized and shaped to receive and hold therein a portion of a user's hand; and
said second handle member comprises as a ring or circular body sized and shaped to receive and hold therein a portion of a user's hand.

7. The device according to claim 5, wherein said first blade member includes an elongated, flat body having a surface, said elongated flat body extending outwardly, towards said second member and terminating in a curved edge.

8. The device according to claim 1, wherein said first member and said second member each end in a tip.

9. The device according to claim 8, wherein said first member tip and said second ember tip is rounded, has a curved portion, or is pointed.

10. The device according to claim 1, wherein said first member comprises a spike or said second member comprises a spike.

11. The device according to claim 1, wherein said second blade member includes a cutting or serrated edge.

12. The device according to claim 1, wherein said first member, said second member, or said first member and said second member is/are made from a food safe material.

13. A device for serving or cutting food comprising:
a first arm comprising a first elongated member extending in a longitudinal direction and a first cutting and member surface;
a second arm comprising a second elongated member extending in a longitudinal direction and a second cutting and holding member, said second arm separated from said first arm by a space; and
a linking area linking said first arm and said second arm.

14. The device for serving or cutting food according to claim 13, wherein,
said first cutting and holding member comprises a main body having a first end and a second opposing end, said first cutting and holding member main body defined by a wall or surface extending outwardly and away from said first arm first elongated member; an
said second cutting and holding member comprises a main body having a first end and a second opposing end, said second cutting and holding member main body defined by a wall or surface extending outwardly and away from said second arm second elongated member.

15. The device according to claim 13, wherein said first arm, said second arm, or said first arm and said second arm move when a force is applied thereto.

16. The device according to claim 13, wherein said first cutting and holding member comprises an outer edge, said outer edge comprising a generally linear section, a first angled section at the first end, and a second angled surface at the second end.

17. The device according to claim 13, wherein said second cutting and holding member comprises an outer edge, said outer edge comprising a generally linear section, a first angled section at the first end, and a second angled surface at the second end.

18. The device according to claim 13, wherein,
said first arm comprises a ridge; and
said first arm comprises a ridge.

19. The device according to claim 13, wherein said first arm comprises a spike or said arm comprises a spike.

20. The device according to claim 13, wherein said linking area comprises an opening.
